(19) United States
(12) Patent Application Publication
(10) Pub. No.: US 2009/0052450 A1
(43) Pub. Date: Feb. 26, 2009

(54) APPARATUS, SYSTEM, AND METHOD FOR VIDEO DELIVERY USING DUAL MULTICAST STREAMS WITH ONE BEING DELAYED

(76) Inventor: Gregory P. Mockett, Spanish Fork, UT (US)

Correspondence Address: HOLMAN IP LAW, 175 S Main Street, Suite #850, Salt Lake City, UT, 84111, US

(21) Appl. No.: 12/194,648

(22) Filed: Aug. 20, 2008

Related U.S. Application Data
(60) Provisional application No. 60/957,410, filed on Aug. 22, 2007.

(51) Int. Cl. H04L 12/56

(52) U.S. Cl. 370/390

(57) ABSTRACT

An apparatus to deliver video over an Internet Protocol (“IP”) network using multicast distribution and unicast correction. The apparatus includes a video receiver module, a multicast module, and a correction signal module. The video receiver module receives one or more videos formatted as IP packets at a first server. The multicast module streams the one or more videos to a user device over a first IP network using a multicast after a time delay. The correction signal module streams the one or more videos to a second server over a second IP network. The second server transmits requested IP packets of a video stream to the user device over a third IP network. The requested IP packets requested by the user device replace missing IP packets from the video stream. The requested IP packets may be combined with a received multicast video stream to form a corrected video stream.

### CROSS-REFERENCE TO RELATED APPLICATIONS

This application claims the benefit of U.S. Provisional Application No. 60/957,410, filed on Aug. 22, 2007, which is incorporated by reference herein in its entirety.

### SUMMARY

Embodiments of an apparatus are described. In one embodiment, the apparatus is to deliver video over an Internet Protocol (“IP”) network using multicast distribution and unicast correction. In one embodiment, the apparatus includes a video receiver module, a multicast module, and a correction signal module. The video receiver module may be configured to receive one or more videos at a first server, the one or more videos formatted as IP packets. In some embodiments, the multicast module is configured to stream the one or more videos to a user device over a first IP network using a multicast. The multicast videos may be streamed after a time delay.

In certain embodiments, the correction signal module is configured to stream the one or more videos to a second server over a second IP network. The second server, in one embodiment, is configured to transmit requested IP packets of a video stream to the user device over a third IP network. The requested IP packets may be requested by the user device to replace IP packets lacking in a corresponding time delayed multicast video stream received by the user device over the first IP network. In some embodiments, the requested IP packets may be combined with a received multicast video stream to form a corrected video stream. Other embodiments of the apparatus are also described.

Embodiments of another apparatus are also described. In one embodiment, the apparatus is an apparatus to deliver video over an Internet Protocol (“IP”) network using multicast distribution and unicast correction. The apparatus may include a correction receiver module, a connection request module, and a connection sending module. The correction receiver module is configured to receive one or more streams of IP packets at a second server from a first server over a second IP network in one embodiment. The one or more streams may be from one or more videos.

In certain embodiments, the correction request module is configured to receive a correction request over a third IP network from a user device. The correction request may be a request for missing IP packets from a stream of IP packets of a first video. The stream of IP packets of the first video transmitted to the user device by the first server may be transmitted over a first IP network by way of a multicast. In some embodiments, the transmitted IP packets at the user device of the first video are time delayed from IP packets of the first video sent from the first server to the second server. The first server, in one embodiment, is configured to stream IP packets from one or more videos to one or more user devices, each stream transmitted by way of a multicast.

The correction sending module, in one embodiment, is configured to transmit requested missing IP packets of the first video to the user device over the third IP network by way of a unicast. The requested missing IP packets of the first video may be used for combination with the stream of IP packets of the first video transmitted to the user device by the first server to form a corrected video stream. Other embodiments of the apparatus are also described.

Embodiments of another apparatus are also described. In one embodiment, the apparatus is an apparatus to deliver video over an Internet Protocol (“IP”) network using multicast distribution and unicast correction. The apparatus may include a receiver module, a packet analyzer module, a packet request module, and a packet assembly module. The receiver module is configured to receive one or more videos from a first server over a first IP network using a multicast in one embodiment. Each of the one or more videos may be formatted as IP packets, and each of the one or more videos received from the first server may be time delayed from a transmission of the same videos to a second server over a second IP network.

The packet analyzer module, in one embodiment, is configured to determine if a stream of IP packets received by the receiver module is missing IP packets. The missing IP packets together with received IP packets from the first server may form a complete sequence of IP packets of a received video. In certain embodiments, the packet request module is configured to request and receive the missing IP packets from a second server over a third IP network. In one embodiment, the packet assembly module is configured to assemble the IP packets of the video received from the first server and the missing IP packets of the video received from the second server into the complete sequence of IP packets forming the video. Other embodiments of the apparatus are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments and are not therefore to be considered to be limiting of its scope, the embodiments will be described and explained with additional specificity and detail through the use of the accompanying drawings, in which:

FIG. 1A is a schematic block diagram illustrating one embodiment of a system to deliver video over an IP network using multicast distribution and unicast correction;

FIG. 1B is a schematic block diagram illustrating an alternate embodiment of a system to deliver video over an IP network using multicast distribution and unicast correction;

FIG. 2 is a schematic block diagram illustrating one embodiment of an apparatus that is part of a first server to deliver video over an IP network using multicast distribution and unicast correction;

FIG. 3 is a schematic block diagram illustrating one embodiment of an apparatus that is part of a second server to deliver video over an IP network using multicast distribution and unicast correction;

FIG. 4 is a schematic block diagram illustrating one embodiment of an apparatus that is part of a user device to deliver video over an IP network using multicast distribution and unicast correction;

FIG. 5 is a schematic flow chart diagram illustrating one embodiment of a method for delivering video over an IP network using multicast distribution and unicast correction; and

FIG. 6 is a schematic flow chart diagram illustrating another embodiment of a method for delivering video over an IP network using multicast distribution and unicast correction.

### DETAILED DESCRIPTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a satellite transmission, an Internet Protocol feed, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

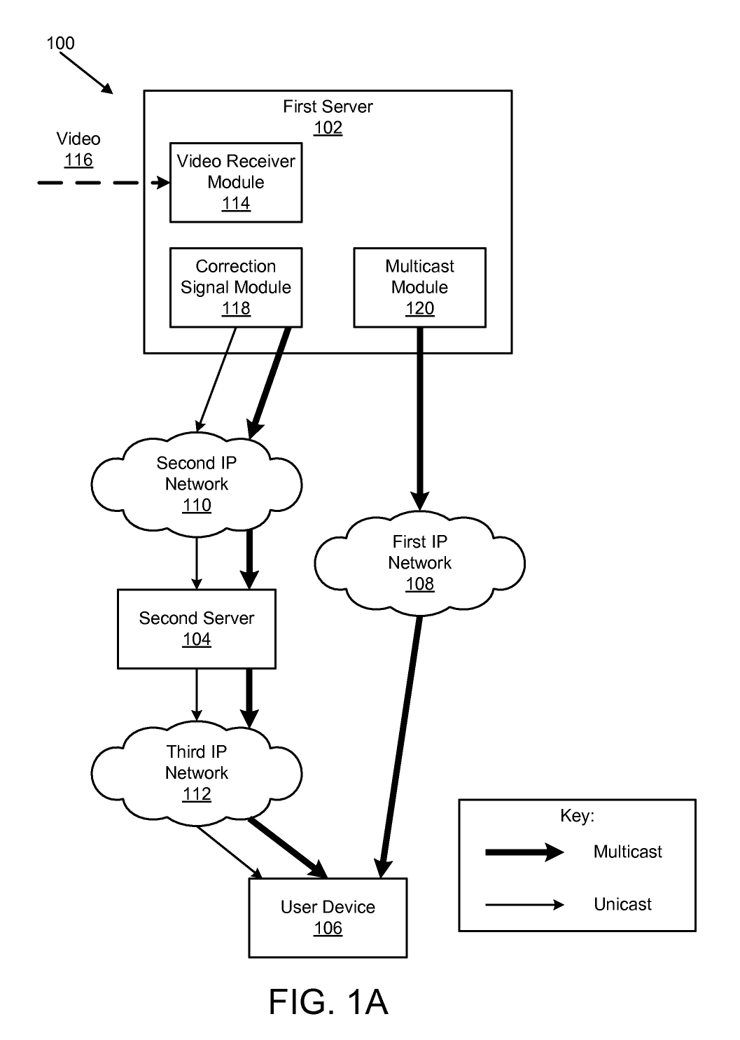

FIG. 1A is a schematic block diagram illustrating one embodiment of a system 100 to deliver video 116 over an IP network using multicast distribution and unicast correction. The system 100 includes a first server 102, a second server 104, and a user device 106. The first server 102 is in communication with the user device 106 over a first IP network 108 and with the second server 104 over a second IP network 110. The second server 104 is in communication with the user device 106 over a third IP network 112. The first server 102 includes a video receiver module 114 that receives a video 116, a correction signal module 118, and a multicast module 120. The servers 102, 104, networks 108, 110, 112, video, 116, and modules 114, 118, 120 are described below.

The system 100 includes a first server 102 in communication with the user device 106 over a first IP network 108 and with the second server 104 over the second network 110. The first server 102 may include one or more computers networked together. The server 102 may include at least one processor, memory, communications buses, etc. Typically, the server 102 serves as a video head end, but may also be connected to a video head end (not shown).

The server 102 includes a video receiver module 114 that receives one or more videos 116. Typically, receiving a video 116 is by way of a video stream. The first server 102 may be in communication with storage devices (not shown) containing one or more videos 116 and the video receiver module 114 may receive the stored videos 116 from the storage devices. The first server 102 may include connections to many other types of storage and devices through which the receiver module may receive videos 116, including satellite and IP-based video streams 116. In one embodiment, a video 116 is loaded from a removable storage device, such as a tape, an optical disk, a digital video disc (“DVD”), a compact disc (“CD”), flash drive, portable hard drive, and the like. In another embodiment, the first server 102 is connected to video and audio streaming sources, either directly or through one or more computers or peripheral equipment.

In one embodiment, the first server 102 is connected to a video provider (not shown) and the video receiver module 114 receives videos 116 from the video provider. For example, a video provider may be a cable television company, a satellite television company, a broadcast or over-the-air television company, etc. In one example, the first server 102 is a head end. In another example, the first server 102 is connected to a head end. One of skill in the art will recognize other embodiments and configurations of a first server 102 with a video receiver module 114 that receives videos 116 for distribution to one or more user devices 106.

A video 116, where referenced herein, includes both video and audio content and may be rich media that includes, in some embodiments, other content such as an interactive overlay. The video 116 may be transmitted as a stream of IP packets. An interactive overlay may include menu information, user-specific information, advertisements, different camera angles, and other information useful in using the video 116. Rich media with an interactive overlay with a method of IP delivery is described in more detail in U.S. patent application Ser. No. 11/747,205 by Gregory P. Mockett, titled “Interactive, Rich-Media Delivery Over an IP Network Using Synchronized Unicast and Multicast,” [hereinafter “the '205 Application”] which is herein incorporated by reference.

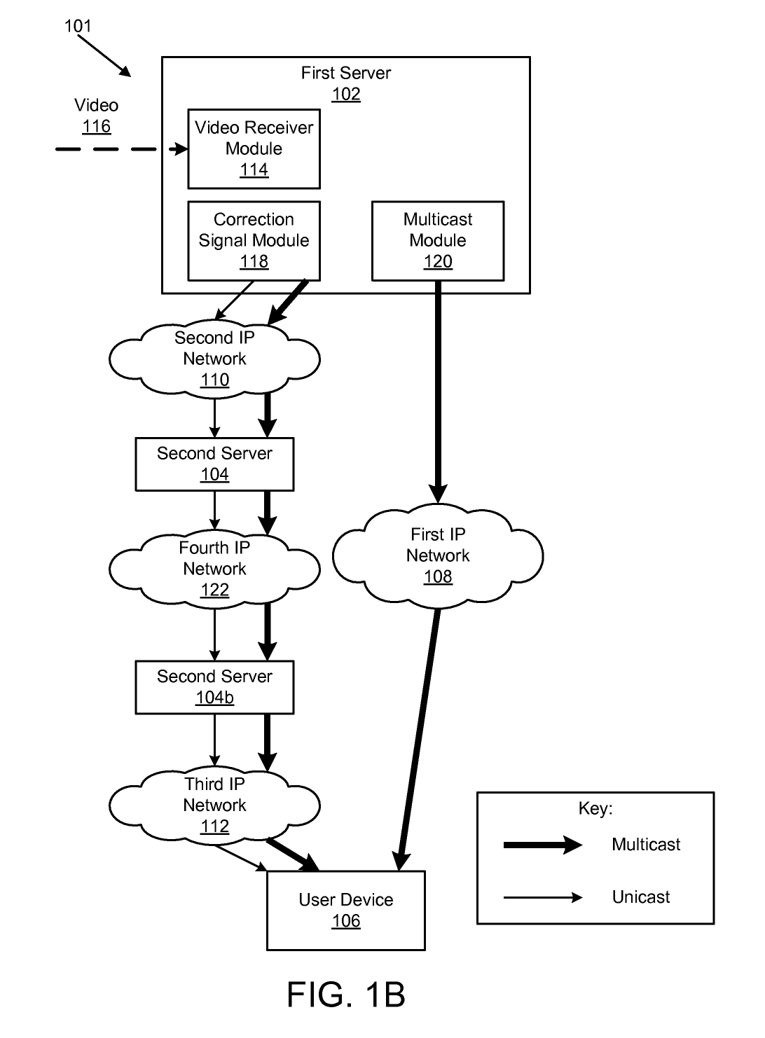

The videos 116 are also formatted in IP packets. In one embodiment, videos 116 are received by the video receiver module 114 already formatted in IP packets. In another embodiment, the videos 116 are formatted into IP packets at the first server 102. In addition, the IP packets of the videos 116 are encoded with sequence information, which will be described in more detail in relation to the apparatus 200 of FIG. 2. Formatting videos 116, files, commands, and other data into IP packets for transmission over an IP network 108, 110, 112 is well known to those of skill in the art.

The system 100 includes a second server 104 that communicates with the first server 102 over the second IP network 110 and with the user device 106 over the third IP network 112. In one embodiment, the second server 104 communicates over one IP network with the first server 102 and the user device 106. The second server 104 may include one or more servers. Typically, the second server 104 is an error correction server providing missing IP packets of a video 116 to a user device 106. As used herein missing IP packets of a video 116 comprise IP packets from a stream of received IP packets that have not been received during a specified time or are IP packets that have been received and are incomplete, defective, or lacking in some way that requires replacement to comprise a complete sequence of IP packets to form video 116. In one embodiment, one or more second servers 104 are at or near the first server 102. In another embodiment, one or more second servers 104 are located remote from the first server 102. In yet another embodiment, one or more second servers 104 are located remote from the first server 102 and one or more second servers 104 are located remote from the second server 104.

Typically, the one or more second servers 104 are sized and configured in quantities suitable for a number of connected user devices 106. For example, one second server 104 may be able to provide missing IP packets from a video stream 116 at a certain rate to a certain number of user devices 106, and exceeding the number of connected user devices 106 may degrade performance below an acceptable level. More second servers 104 may be supplied to avoid performance degradation. One of skill in the art will recognize how to configure one or more second servers 104 to serve a particular number of user devices 106.

Missing IP packets may be due to signal loss or other problems in transmitting the video 116 from the first server 102 to the user device 106, or may be supplied to the user device 106 as a result of a channel change. Typically the second server 104 is capable of supplying IP packets after a channel change faster than the first server 102 because the video 116 is time delayed prior to transmission from the first server 102 to the user device 106. By supplying the IP packets from the second server 104, a user device 106 usually waits less time for video 116 content than if the video content 116 is supplied only from the first server 102 as a time delayed multicast. The second server 104 may supply IP packets of a requested video 116 until IP packets corresponding to the newly selected channel arrive over the first IP network 108 from the first server 102.

The second server 104 may also provide IP packets missing from a stream of IP packets received from the first server 102. The second server 104 may provide the missing IP packets by way of a unicast which allows the second server 104 to supply the missing IP packets relatively quickly. The second server 104, for example, may send a burst of IP packets to the user device 106 at a rate higher than the user device 106 typically receives packets from the first server 102. In another embodiment, the second server 104 supplies IP packets to the user device 106 using a multicast.

The system 100 includes first IP network 108, a second IP network 110, and a third IP network 112. In one embodiment, the IP networks 108, 110, 112 comprise one network, such as the Internet, configured to transmit IP packets. In another embodiment, one or more of the IP networks 108, 110, 112 are separate. In one embodiment, all or part of an IP network 108, 110, 112 may be a public network where the remaining networks 108, 110, 112 or portions of a network are private. A private network may limit content and Internet traffic sent to a user device 106. A private network may include a network within a company or may include a large private network such as one owned by a cable company, a telephone company, a company providing electronic media access through a satellite service, etc.

For example, the first server 102 may connect to a public network that in turn connects to a private network for final distribution of a video 116. A first server 102 may send a video 116 over the Internet, but a user device 106 that is the intended target of the video 116 may connect to a private Internet provider. In this example, the first IP network 108 may include a portion within a public network and a portion within the private network supplying the user device 106. In another example, the first server 102 is located within a private network or at a boundary between the private network and a public network and the first, second, and third IP networks 108, 110, 112 are one or more private networks.

A second server 104 may also be connected to a public or a private network. For example, a second server 104 may connect to a public, second IP network 110 and to a private, third IP network 112. In another embodiment, both the second and third IP networks 110, 112 may be connected to public networks. Second servers 104 may be centrally located or may be distributed to service user devices 106 connected to various pubic and private networks.

One advantage of an IP transmission of a video 116 is that the video 116 can travel over the Internet as an over-the-top (“OTT”) transmission rather than as a locally ingested and sourced transmission. A video 116 transmission, such as a television signal provided by a video content producer, such as a television or cable network company, and sent to a television distributor, such as a cable company, a satellite television company, etc., is typically regulated by a licensing agreement. However, if an owner of a private IP network agrees with a user device 106 to provide Internet access services, typically the private IP network is obligated to allow the user device 106 to access anything available on the Internet—including OTT transmissions of a video 116. While blocking access to a particular IP address is possible, a private network has a much harder time limiting OTT transmissions based on user agreements and expectations. The present invention can be a way for a small company or even an individual to inexpensively provide a secure, reliable television signal to any user device 106 wishing to join a transmission of that television signal.

Typically, the first server 102 transmits a video 116 to the user device 106 using a multicast. A multicast is beneficial because a multicast video 116 may be transmitted once from the first server 102. Routers along a transmission path through the first IP network 108 maintain IP packets of the streamed video 116 only if servicing a user device 106 joining the multicast. A multicast is advantageous over a broadcast or unicast when simultaneously servicing many user devices 106 with the same content over an IP network 108, 110, 112. A broadcast over an IP network 108, 110, 112 typically sends multiple copies of transmitted data—one to each user device 106. A unicast over an IP network 108, 110, 112 typically requires that a connection to a user device 106 be maintained. A unicast and a broadcast require much more network bandwidth to service numerous user devices 106 than a multicast. For a more in-depth example of a multicast, see the '205 Application.

A disadvantage of a multicast, however, is that typically a multicast is a one-way communication from a source. If a user device 106 encounters any problems with received IP packets, the user device 106 typically has no recourse. The present invention, however, combines the advantages of delivery of bandwidth-intensive media, such as a video 116 with the bi-directional, relatively fast characteristics of a unicast. A unicast may be used to supply missing IP packets or to quickly supply video 116 content after a channel change prior to receipt of IP packets over the first IP network 108 by way of a multicast. By delaying the multicast signal, the user device 106 typically does not notice the delay, but the first server 102 has time to fill video buffers in a second server 104 for error correction and to decrease the effects of a channel change.

By splitting the first server 102 from the second server 104, the second server 104 can be strategically placed and duplicated to service the needs of numerous user devices 106 while the first server 102 may continue to transmit a single copy of a video 116 that will reach the numerous user devices 106 by way of a multicast. The first server 102 may then multicast the video 116 to multiple second servers 104, preserving the advantages of multicasting, and then the second server 104 can unicast the video 116 to individual user devices 106 as needed on demand in high-speed bursts, thus servicing numerous user devices 106 quickly.

A solution limited to a single box for unicasting and multicasting of a video 116 is very limited. To service many user devices 106, the single box must be replicated numerous times to be able to efficiently service the user devices 106. Replicated single box solutions would also take up numerous multicast addresses, which are currently very limited in number. On the other hand, a single box serving as a head end could only service a limited number of user devices 106 due to limitations associated with the unicast correction signal.

The first server 102 includes a correction signal module 118 that streams the one or more videos 116 to a second server 104 over the second IP network 110. The second server 104 then transmits requested IP packets of a video stream to a user device 106 using a unicast over the third IP network 112, or a multicast if available and useful. The requested IP packets are requested by the user device 106 to replace IP packets lacking in a corresponding time delayed multicast video stream received by the user device 106 over the first IP network 108. The requested IP packets are then combined by the user device 106 with the received multicast video stream to form a corrected video stream.

In one embodiment, the correction signal module 118 streams one or more videos 116 to one or more second servers 104 using a multicast. In another embodiment, the correction signal module 118 transmits one or more videos 116 to a second server 104 using a unicast. The correction signal module 118 may also send the one or more videos 116 to multiple seconds servers 104 using one or more unicast transmissions. In another embodiment, the correction signal module 118 sends the one or more videos 116 using a multicast and one or more unicasts. One of skill in the art will recognize other ways of using unicasts, multicasts, and broadcasts, or other IP network to send the one or more videos 116 to one or more second servers 104.

The first server 102 includes a multicast module 120 that streams the one or more videos 116 to a user device 106 over the first IP network 108 typically using a multicast. In another embodiment, the multicast module 120 transmits the one or more videos 116 to a user device 106 using a unicast. In other embodiments, the multicast module 120 transmits the one or more videos 116 using other transmission means, such as a broadcast, anycast, etc. The multicast module 120 streams the one or more videos 116 after a time delay. For example, if a video 116 is transmitted by the correction signal module 118 at time T, the multicast module 120 transmits the same video 116 at time T+TD where TD is a time delay. The time delay allows buffers in the second server 104 to be filled with IP packets of a video 116 for error correction and accelerating channel changes prior to transmitting the same video 116 to a user device 106.

In another embodiment, the multicast module 120 transmits a time delayed video 116 in multiple streams. For example, the first server 102 or other video source may maintain or prepare a copy of the video 116 to be sent in a component form. The video 116 may be divided into RGB analog component video streams, Y′P_{b}Pᵣ analog component video streams, S-Video analog component video streams, or other analog component-type video streams, which are then digitally encoded into streams. Transmitting multiple streams of a video 116 or rich media source is discussed in detail in the '205 Application.

FIG. 1B is a schematic block diagram illustrating an alternate embodiment of a system 101 to deliver video 116 over an IP network using multicast distribution and unicast correction in accordance with the present invention. The system 101 includes a first server 102, a second server 104, a user device 106, a first IP network 108, a second IP network 110, a third IP network 112, a video receiver module 114, a video 116, a correction signal module 118 and a multicast module 120, which are substantially similar to those described above in relation to the system 100 of FIG. 1A. In addition, the system 101 includes another second server 104b and a fourth IP network 122 in communication with the two second servers 104, 104b, which are described below.

In an extended network, the embodiment of the system 101 depicted in FIG. 1B may be advantageous to deliver correction packets to a user device 106. The system 101 includes a fourth IP network 122 in communication with the two second servers 104, 104b. The fourth IP network 122 is similar to the other IP networks 108, 110, 112 and may be a separate network or part of one or more of the other IP networks 108, 110, 112. The fourth IP network 122 may be public, private, or a combination of both. One of skill in the art will recognize other forms of a fourth IP network 122.

The system 101 includes two second servers 104, 104b where one supplies video 116 content to the other, which in turn supplies missing IP packets to the user device 106. For example, the second server 104 supplying IP packets to a user device 106 may be located at a public/private network boundary. In another embodiment, the number and location of user devices 106 receiving videos 116 may make multiple second servers 104, 104b attractive for efficiency of transmission, network configuration convenience, transmission speed, etc. In another example, the system 101 includes multiple second servers 104, 104b where at least two second servers 104, 104b are configured as depicted. Other configurations may also be implemented using three or more second servers 104, 104b in series to deliver video 116 from a first server 102 to a user device 106.

FIG. 2 is a schematic block diagram illustrating one embodiment of an apparatus 200 that is part of a first server 102 to deliver video 116 over an IP network 108, 110, 112 using multicast distribution and unicast correction in accordance with the present invention. The apparatus 200 includes a video receiver module 114 that receives a video 116, a correction signal module 118, and a multicast module 120, which are substantially similar to those described in relation to the system 100 of FIG. 1A. In addition, the apparatus 200 may include a forward error correction module 202, an FEC dynamic adjustment module 203, and an encoding module 204, and the correction signal module 118 includes a unicast/multicast module 206, which are described below.

The apparatus 200, in one embodiment, includes a forward error correction module 202 that adds forward error correction (“FEC”) information to the video 116 prior to being streamed by the first server 102 to the user device 106 over the first IP network 108. The FEC information added to the video 116 is sufficient to reproduce a missing IP packet of a group of IP packets of a received multicast video stream at the user device 106. The group includes a pre-selected number of sequential IP packets. The user device 106 is able to reproduce missing IP packets of the received multicast video 116 stream using the FEC information prior to requesting additional missing IP packets for the received multicast video stream from the second server 104.

Forward error correction is predictive instead of reactive in that a certain error in a streamed signal must be assumed prior to encoding FEC information into a video 116 at a source (first server 102). For example, if a 1% error rate is assumed, a group size may be 100 IP packets assuming 1 in 100 IP packets will be missing. As long as no more than 1 IP packet out of 100 IP packets is missing, the FEC information will be sufficient to reproduce any missing IP packets. However, if two or more IP packets out of a group of 100 IP packets are missing, the video 116 stream cannot be corrected with FEC.

To counter this problem, the error rate may be raised. For example, the error rate may be raised to 5% so that a group size is 20 IP packets. However, for certain signals the error rate may be higher. For example satellite signals are subject to weather related problems. During a snow storm up to 50% of a signal may be lost. An error rate of 5% would still not be enough error correction for a satellite system in a snow storm. To handle a 50% error rate, the IP group would be two IP packets.

Obviously, as the assumed error rate is raised, transmission efficiency decreases. A tradeoff between error correction and transmission efficiency may be studied to determine an optimal forward error correction rate knowing that any error above the assumed rate will result in poor picture quality at the user device 106. While this may have been acceptable in the past, currently with High Definition (“HD”) and Blu-Ray™ television looming, previously acceptable error is no longer tolerated by users. Forward error correction alone cannot reliably produce an error-free video 116 at a user device 106.

However, the present invention is advantageous because both forward error correction, which is predictive, and error correction using the second server 104, which is reactive, can be used to provide an optimal video 116 delivery system. Using forward error correction in conjunction with reactive error correction from the second server 104, an optimal error correction rate for the forward error correction can be selected. The optimal rate can be chosen to be lower than for forward error correction alone because the reactive error correction from the second server 104 can be relied upon to correct any error above the selected error correction rate for forward error correction. At the same time, by using forward error correction, the selected time delay between the video 116 transmitted by the correction signal module 118 to the second server 104 and the time delayed video 116 sent by the multicast module 120 to the user device 106 can be reduced. Buffer sizes in the second server 104 may also be reduced when forward error correction is used.

Typically, IP packets are encapsulated and a header is added as the IP packets are prepared for transmission. Typically, the highest level of encapsulation includes a header with router information of the next router in an IP network 108, 110, 112 along a path from source (first server 102) to user device 106 (call the header H1). Another encapsulation may include encoding an IP packet with sequence information (see the '205 application), video 116 information such as a title or other identifying information, and other information useful for the user device 106 to unwrap and use the IP packet. The information is typically also put in a header (H2).

Another encapsulation includes an FEC header. In one embodiment, the forward error correction module 202 encapsulates IP packets with FEC information such that the FEC information is in a packet header ahead of the H2 header. This allows the user device 106 to use the FEC information and replicate missing IP packets prior to reading sequence information and determining if any further error correction is required from the second server 104. One of skill in the art will recognize forward error correction techniques and routines useful to provide forward error correction in conjunction with multicasting a time delayed video 116 to a user device 106. One of skill in the art will also recognize how to encapsulate IP packets to do FEC prior to reactive error correction using video information 116 located at the second server 104.

In one embodiment, the apparatus 200 includes an FEC dynamic adjustment module 203 that dynamically adjusts an error rate used by the forward error correction module 202. Advantageously, by including both FEC correction and reactive correction using a multicast or unicast, FEC correction is not required to be fixed or selected to be above a predicted error rate. The FEC dynamic adjustment module 203 may gather data such as number of missing IP packets requested by a user device 106 and may then use the gathered information to adjust the error rate used by the forward error correction module 202 up or down.

If an excessive amount of missing IP packets are being requested by user devices 106, the FEC dynamic adjustment module 203 may increase the error rate so the forward error correction module 202 may encode IP packets so more missing or corrupted IP packets of a video 116 may be corrected at the user device 106 with FEC information, thus reducing demand at the second server 104 to supply missing IP packets. On the other hand, if missing IP packets requested by user devices 106 is low, the FEC dynamic adjustment module 203 may decrease the error rate used by the forward error correction module 202. With a decrease in error correction rate, the forward error correction module 202 may include FEC information at a lower rate so that transmission efficiency will be increased for sending IP packets of a video 116 to user devices 106. The number of missing packets requested from the second server 104 may then increase.

The FEC dynamic adjustment module 203 may trade transmission efficiency of sending IP packets of a video 116 from the first server 102 to user devices 106 with second and third IP network 110, 112 traffic based on missing IP packets requested from the second server 104. While the FEC dynamic adjustment module 203 is shown in the first server 102, portions of the FEC dynamic adjustment module 203 may also be included at the user device 106 and the second server 104. One of skill in the art will recognize other factors to be considered and other ways to dynamically adjust the FEC error rate.

In another embodiment, the apparatus 200 includes an encoding module 204 that encodes IP packets of a video 116 with a sequence identifier. Each sequence identifier identifies a location of an IP packet with respect to other IP packets of a video 116 and can be used to reassemble a video 116 at a user device 106. Sequence identifiers may be unique to each video 116. By adding sequence information, such as a time stamp or number, a user device 106 can evaluate a video 116 stream and determine if any IP packets are missing and can identify the missing packets to request from the second server 104. Typically the user device 106 has a buffer because IP packets of a video 116 received by way of a multicast may be out of order, may arrive at an inconsistent rate, or some of the IP packets may be missing.

Once the user device 106 determines that IP packets are missing, the user device 106 requests over a unicast connection the missing IP packets from the second server 104. The second server 104 typically returns the missing IP packets by way of a unicast, but may also send the missing IP packets using a multicast. The second server 104 may send missing IP packets by way of a multicast if more than one user device 106 is requesting the missing IP packets.

In one embodiment, the encoding module 204 encodes IP packets of a video 116 with sequence information. In another embodiment, the encoding module 204 encodes IP packets of multiple streams of a video 116 with sequence information. Where multiple streams are encoded, sequence information is included in each stream so that the user device 106 can combine the streams into a video 116 in the proper sequence. In another embodiment, the encoding module 204 receives a video 116 that has been previously encoded with sequence information.

In one embodiment, the encoding module 204 includes a different identifier for IP packets of a video 116 sent from the first server 102 to the user device 106 in a delayed multicast than IP packets for the video 116 sent to the second server 104. Advantageously, this embodiment may allow a user device 106 or second server 104 to analyze how IP packets are arriving. For example, a user device 106 may determine a quantity of missing IP packets used to reconstruct a video 116 in relation to a quantity of IP packets received directly from the first server 102 using a multicast. The information may be used for diagnostics to readjust the FEC error rate, select a unicast or multicast, etc. One of skill in the art will recognize other ways to encode IP packets of a video 116 with sequence information sufficient for a user device 106 to determine if any IP packets are missing and to reassemble the IP packets to form the video 116 into its original sequence.

In one embodiment, the correction signal module 118 includes a unicast/multicast module 206 that streams the one or more videos 116 to the second server 104 using a multicast and transmits correction IP packets to the second server 104 using a unicast as requested by the second server 104. The requested IP packets are requested by the second server 104 to replace IP packets lacking in the one or more multicast videos 116 received by the second server 104.

If many user devices 106 are served by a first server 102, multiple second servers 104 may be required to service the user devices 106 efficiently. An efficient way to send a video 116 to the user devices 106 is by way of a multicast. In the same way that a user device 106 may encounter signal loss and may not receive all IP packets of a video 116, the second server 104 may also experience problems receiving all IP packets of a video 116 sent using a multicast. The unicast/multicast module 206, in one embodiment, sends one or more videos 116 to the second servers 104 using a multicast. When requested, the unicast/multicast module 206 then responds to a request from a second server 104 to replace missing IP packets of a video 116 by sending the missing IP packets to the second server 104 by way of a unicast. In another embodiment, the missing IP packets are sent to the second server 104 by way of a multicast. The unicast/multicast module 206 may improve the efficiency of video 116 transmission from the first server 102 to multiple second servers 104 by using a multicast to send the video 116 and a unicast to send missing IP packets.

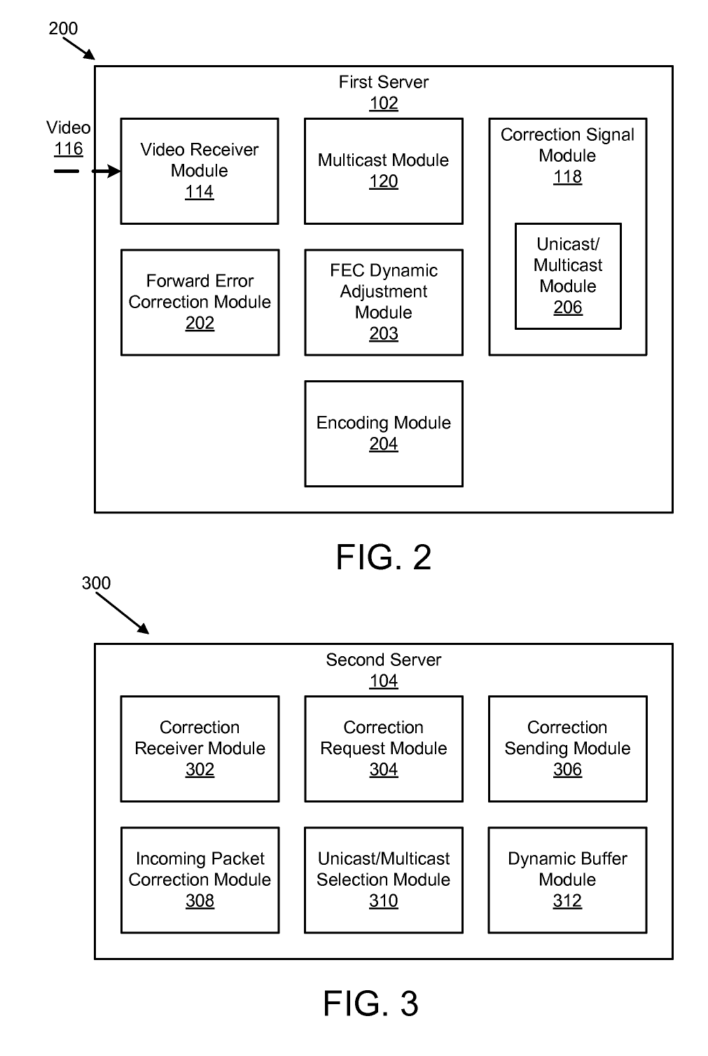

FIG. 3 is a schematic block diagram illustrating one embodiment of an apparatus 300 that is part of a second server 104 to deliver video 116 over an IP network 108, 110, 112 using multicast distribution and unicast correction in accordance with the present invention. The apparatus 300 includes a second server 104 with a correction receiver module 302, a correction request module 304, a correction sending module 306, an incoming packet correction module 308, a unicast/multicast selection module 310, and a dynamic buffer module 312, which are described below.

The apparatus 300 includes a correction receiver module 302 that receives one or more streams of IP packets at the second server 104 from the first server 102 over the second IP network 110 where the one or more streams are from one or more videos 116. The correction receiver module 302, in one embodiment, receives IP packets by way of a multicast. In another embodiment, the correction receiver module 302 receives IP packets by way of a unicast. In another embodiment, the correction receiver module 302 receives IP packets by way of a multicast and then requests and receives missing IP packets by way of a unicast or multicast. One of skill in the art will recognize other ways that the correction receiver module 302 can receive IP packets from one or more videos 116 over the second IP network 110 from the first server 102.

The apparatus 300 includes a correction request module 304 that receives a correction request over the third IP network 112 from a user device 106. The correction request includes a request for missing IP packets from a stream of IP packets of a first video 116. The stream of IP packets of the first video 116 is received by the user device 106 from the first server 102 over the first IP network 108 typically by way of a multicast. In one embodiment, the request from the user device 106 is a result of IP packets that are missing from a stream of IP packets for the first video 116 from the first server 102.

In another embodiment, the request from the user device 106 is a result of a channel change by the user device 106 so that the user device 106 requests IP packets from a first video 116 while waiting for IP packets of the first video 116 to arrive from the first server 102 after a time delay. Typically after a channel change, the user device 106 will join a transmission of the first video 116 from the first server 102. The multicast of the first video 116 is delayed and a multicast is sent using a fixed transmission rate. Many users would view the time required to join the multicast of the first video 116 from the first server 102 to be unacceptable. To hasten the channel change, a request is sent to the second server 104 to supply IP packets ahead of IP packets received from the first server 102. As explained above, because packets can be sent from the second server 104 in a burst by way of a unicast, the user device 106 can start displaying the first video 116 sooner than merely waiting for IP packets from the first server 102.

The apparatus 300 includes a correction sending module 306 that transmits the requested missing IP packets of the first video 116 to the user device 106 over the third IP network 112 by way of a unicast or multicast. The requested missing IP packets of the first video 116 are typically combined at the user device 106 with the stream of IP packets of the first video 116 received by the user device 106 from the first server 102 to form a corrected video stream.

While the request for missing packets is typically sent to the second server 104 using a unicast, the correction sending module 306 may transmit the requested missing IP packets by multicast, by unicast, or by other IP transmission means. For example, if many user devices 106 are lacking a common set of IP packets from the first video 116, the second server 104 may send the IP packets by way of a multicast. The correction sending module 306 may also send missing IP packets using a unicast which may provide speed advantages over a multicast. In one embodiment, the correction sending module 306 maintains a multicast repair channel to the user device 106. The multicast repair channel may be sending empty packets until missing packets are required.

When the correction sending module 306 is not sending requested IP packets, has unused capacity, or otherwise is able to send additional data, it may transmit an interactive overlay that may contain advertising or other data directed to a user device 106, a group of user devices 106, or even all user devices 106. An interactive overlay is discussed in detail in the '205 application.

The apparatus 300, in one embodiment, includes an incoming packet correction module 308 that requests from the first server 102 IP packets of a video 116 and receives the requested IP packets. Typically, incoming packet correction module 308 works in conjunction with the unicast/multicast module 206 and IP packets are requested to replace IP packets missing from a stream of IP packets of a video 116 received from the first server 102 by way of a multicast.

In one embodiment, the apparatus 300 includes a unicast/multicast selection module 310 that communicates with the first server 102 and selects a unicast or multicast to receive the video 116 and/or missing packets from the video 116 from the first server 102. The unicast/multicast selection module 310 may consider factors such as number of user devices 106 being serviced by the second server 104, IP network 108, 110, 112 traffic, commonality of missing IP packets, etc. The unicast/multicast selection module 310 may include an algorithm to dynamically determine whether IP packets from a video 116 transmission or IP packets determined to be missing from the transmission should be sent from the first server 102 using a unicast or a multicast.

For example, if a second server 104 is servicing a low number of user devices 106, the unicast/multicast selection module 310 may send a message to the first server 102 to send IP packets for a video 116 using a unicast so that one or more multicast addresses being used by the second server 104 may be reassigned. In another example, the unicast/multicast selection module 310 may determine that a video 116 should be transmitted using a multicast and correction packets determined to be missing from the multicast should be sent using a separate unicast. In another embodiment, the unicast/multicast selection module 310 determines that the correction packets should be sent using a multicast. One of skill in the art will recognize other factors to use in selecting a unicast or a multicast for reception of IP packets from a video 116 or corresponding correction packets from a first server 102.

In another embodiment, the unicast/multicast selection module 310 selects a unicast or a multicast to send IP packets to one or more user devices 106. Again the unicast/multicast selection module 310 may consider factors such as number of user devices 106 services, network 108, 110, 112 traffic, etc. For example, if the unicast/multicast selection module 310 determines that only a relatively small number of user devices 106 have joined a multicast session, the unicast/multicast selection module 310 may send correction packets to the user devices 106 by way of a unicast. In another example, if the unicast/multicast selection module 310 determines that a relatively large number of user devices 106 require the same correction IP packets, the unicast/multicast selection module 310 may select a multicast to send the correction IP packets to the user devices 106.

In one embodiment, unicast/multicast selection module 310 may select a multicast for transmission of IP packets either between the first server 102 and second server 104 or between the second server 104 and a user device 106 and may keep a multicast connection alive by sending “empty” packets when no missing IP packets are required or requested. In another embodiment, the keep alive multicast connection transmits an interactive overlay when not transmitting requested IP packets or is otherwise able to send additional data. The interactive overlay may include advertising information, account data, or other information tailored to a user. By maintaining a multicast connection, time required for handshaking and other steps required to establish a connection may be avoided. A multicast “keep-alive” connection may offer advantages over a unicast.

One of skill in the art will recognize other factors to consider and ways to determine if correction packets requested by one or more user devices 106 should be sent from the second server 104 by a unicast or multicast. While the functions of the unicast/multicast selection module 310 are shown as part of the apparatus 300 if FIG. 3, one or more functions of the unicast/multicast selection module 310 may be included with a user device 106 or the first server 102.

In one embodiment, the apparatus 300 includes a dynamic buffer module 312 that determines system delays and adjusts one or more buffers in the second server 104, first server 102, and user device 106. In another embodiment, each of the first server 102, second server 104, and user device 106 have a dynamic buffer module 312. In yet another embodiment, the first server 102 includes a dynamic buffer module 312 that adjusts the buffers of the first server 102, second server 104, and user device 106. In yet another embodiment, a dynamic buffer module 312 in the user device 106 controls the buffer sizes of the user device 106 as well as the first and second servers 102, 104.

For example, if the dynamic buffer module 312 determines that due to the level of forward error correction, requested IP packets, etc., that the buffer for the second server 104 is too large or too small, the dynamic buffer module 312 may dynamically adjust the size of the buffer. The dynamic buffer module 312, in one embodiment coordinates with the FEC dynamic adjustment module 203 to size buffers based on an amount of error correction encoded in IP packets of a video 116. The dynamic buffer module 312 may use any relevant factor such as history of buffer usage, video 116 size, expected IP network 108, 110, 112 delay times, etc. One of skill in the art will recognize other ways to dynamically size buffers of the first server 102, second server 104, and user device 106.

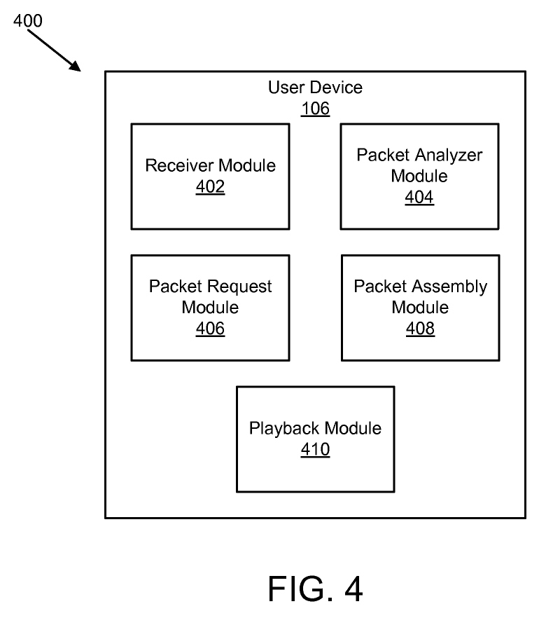

FIG. 4 is a schematic block diagram illustrating one embodiment of an apparatus 400 that is part of a user device 106 to deliver video 116 over an IP network 108, 110, 112 using multicast distribution and unicast correction in accordance with the present invention. The apparatus 400 includes a receiver module 402, a packet analyzer module 404, a packet request module 406, a packet assembly module 408, and a playback module 410, which are described below.

The apparatus 400 includes a receiver module 402 that receives one or more videos 116 from the first server 102 over the first IP network 108 using a multicast. The videos 116 are formatted as IP packets. The one or more videos 116 received from the first server 102 are time delayed from a transmission of the same videos 116 to the second server 104 over the second IP network 110. In another embodiment, the receiver module 402 receives the one or more videos 116 using a unicast. In another embodiment, the receiver module 402 receives multiple streams of a video 116. In yet another embodiment, the receiver module 402 receives encrypted IP packets and decrypts the encrypted IP packets. Typically the receiver module 402 stores the received IP packets in a buffer.

The apparatus 400 includes a packet analyzer module 404 that determines if a stream of IP packets received by the receiver module 402 is missing IP packets. The missing IP packets together with received IP packets from the first server 102 form a complete sequence of IP packets of a received video 116. In one embodiment, the IP packets received by the receiver module 402 include FEC information and the packet analyzer module 404 applies the FEC information to reform missing IP packets. The packet analyzer module 404 uses FEC algorithms to reconstruct missing IP packets. The packet analyzer module 404 then determines if still more IP packets are missing or corrupted.

The packet analyzer module 404 typically works in conjunction with a buffer and determines if an IP packet is missing after the IP packet has not arrived at the user device 106 within a prescribed time period. For example, the receiver module 402 may receive IP packets out of sequence due to inefficiencies, differing transmission paths, etc. within the first IP network 108. The packet analyzer module 404 typically sorts IP packets by a video identifier and then by sequence number. In another embodiment, the video identifier and sequence number of a video 116 are combined into one identifier.

In another embodiment, the packet analyzer module 404 determines if an IP packet of a video 116 is deficient, corrupted, or lacking in some way. In another embodiment, the packet analyzer module 404 determines that an IP packet must be replaced if the receiver module 402 is unable to decrypt the received packet. One of skill in the art will recognize other functions of a packet analyzer module 404 in determining if there are missing or corrupted IP packets from IP packets of a received video 116.

The apparatus 400 includes a packet request module 406 that requests and receives the IP packets of a video 116 determined to be missing or otherwise lacking by the packet analyzer module 404. The packet request module 406 requests the missing IP packets from the second server 104 over the third IP network 112 In one embodiment, the packet request module 406 requests packets of a video 116 as a result of a channel change so that IP packets of the newly selected video 116 may be received, assembled by the packet assembly module 408, and played by the playback module 410 while the receiver module 402 is joining a multicast of the video 116, which is time delayed from packets that may be accessed through the second server 104. This channel change acceleration reduces the time the user device 106 must wait for video 116 to be displayed while changing channels.

The packet request module 406 receives the missing IP packets, in one embodiment, by way of a unicast. In another embodiment, the packet request module 406 receives the missing IP packets from the second server 104 by way of a multicast. In another embodiment, the packet request module 406 maintains a “keep-alive” multicast connection with the second server 104 and receives empty packets when no missing IP packets are requested.

The apparatus 400 includes a packet assembly module 408 that assembles the IP packets of the video 116 received from the first server 102 and the missing IP packets of the video 116 received from the second server 104 into a complete sequence of IP packets forming the video 116. The packet assembly module 408 typically uses sequence identifiers delivered with the IP packets to assemble the video 116 in numerical order or other sequence so that the video 116 sequence matches the sequence of the video 116 transmitted from the first server 102.

In one embodiment, the apparatus 400 includes a playback module 410 that plays back the complete sequence of IP packets as a video 116 with both video and audio content. In another embodiment, the playback module 410 may play back interactive overlay information delivered either from the first server 102 over the first IP network 108 or from the second server 104.

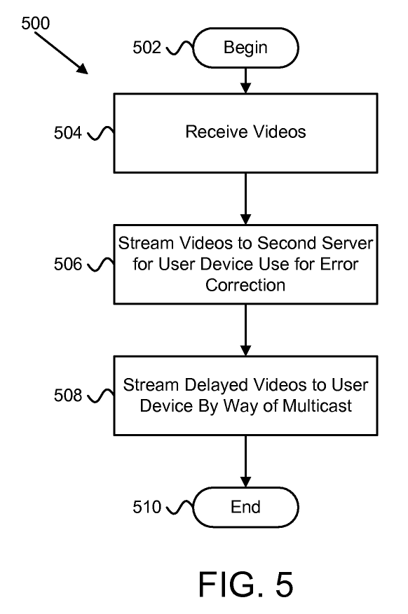

FIG. 5 is a schematic flow chart diagram illustrating one embodiment of a method 500 for delivering video 116 over an IP network 108, 110, 112 using multicast distribution and unicast correction in accordance with the present invention. The method 500 begins 502 and the video receiver module 114 receives 504 one or more videos 116. The correction signal module 118 streams 506 the one or more videos 116 to the second server 104 for a user device 106 to use for error correction as replacement IP packets missing from a video 116 transmission or after a channel change. Typically the correction receiver module 302 at the second server 104 receives the IP packets of the videos 116. The multicast module 120 streams 508 the videos 116 typically by way of a multicast to the user device 106 after a time delay and the method 500 ends 510.

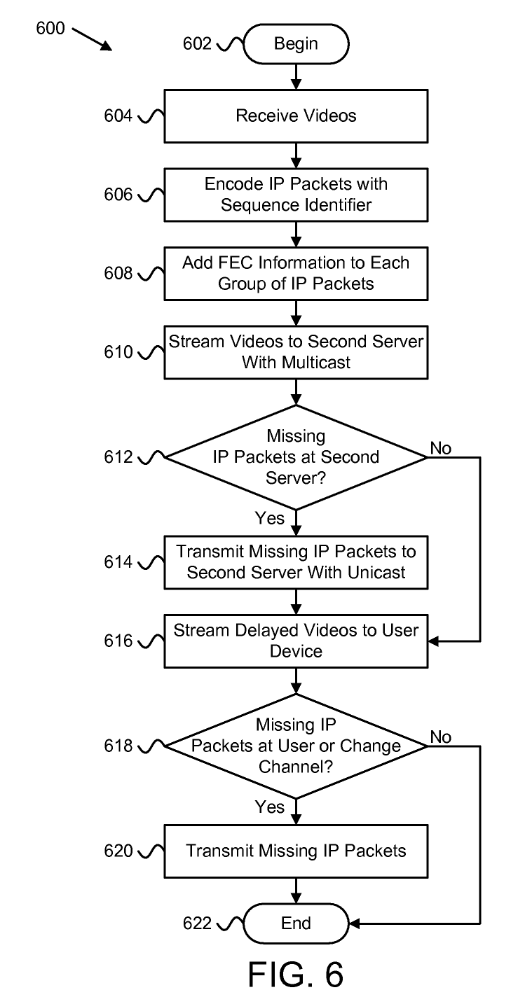

FIG. 6 is a schematic flow chart diagram illustrating another embodiment of a method 600 for delivering video 116 over an IP network 108, 110, 112 using multicast distribution and unicast correction in accordance with the present invention. The method 600 begins 602 and the video receiver module 114 receives 604 one or more videos 116. The encoding module 204 encodes 606 IP packets of the videos 116 with sequence information or receives an encoded video 116. The forward error correction module 202 adds 608 FEC information to each group of IP packets based on a pre-selected group of IP packets or, in another embodiment, receives a video 116 with FEC information. The pre-selected group is based on a selected level of forward error correction. In one embodiment, FEC information is included with IP packets sent to the user device 106 over the first IP network 108. In another embodiment, the FEC information is included with IP packets sent both to the user device 106 and to the second server 104.

In the depicted embodiment, the unicast/multicast module 206 of the correction signal module 118 streams 610 the encoded IP packets of the one or more videos 116 to the second server 104. The incoming packet correction module 308 of the second server 104 determines 612 if there are any missing IP packets at the second server 104. If the incoming packet correction module 308 determines 612 that there are missing IP packets at the second server 104, the incoming packet correction module 308 requests the missing packets from the first server 102 and the unicast/multicast module 206 transmits 614 the missing IP packets to the second server 104 typically by way of a unicast. The multicast module 120 streams time delayed IP packets of the videos 116 to the user device 106.

If the incoming packet correction module 308 determines 612 that there are no missing IP packets at the second server 104, the multicast module 120 moves ahead to the next step without transmitting 614 missing IP packets and streams 616 time delayed IP packets of the videos 116 to the user device 106. The user device 106 determines 618 if there are IP packets missing from a video 116 stream received from the first server 102 either as a result of an error in transmission or due to a channel change. If the user device 106 determines 618 that there are missing IP packets from the time delayed multicast of the video 116 from the first server 102, the user device 106 requests the missing packets from the second server 104, which is typically received by the correction request module 304, and the correction sending module 306 at the second server 104 transmits 620 the missing packets to the user device 106 using a unicast or, in another embodiment using a multicast, and the method 600 ends 622. If the user device 106 determines 618 that there are no missing IP packets, the method 600 ends 622.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to deliver video over an internet protocol (“IP”) network using multicast distribution and unicast correction, the apparatus comprising:
a video receiver module configured to receive one or more videos at a first server, the one or more videos formatted as IP packets;
a multicast module configured to stream the one or more videos to a user device over a first IP network using a multicast, the multicast videos streamed after a time delay; and
a correction signal module configured to stream the one or more videos to a second server over a second IP network, the second server configured to transmit requested IP packets of a video stream to the user device over a third IP network, the requested IP packets requested by the user device to replace IP packets lacking in a corresponding time delayed multicast video stream received by the user device over the first IP network, the requested IP packets being combined with a received multicast video stream to form a corrected video stream.

2. The apparatus of claim 1, further comprising a forward error correction module configured to add forward error correction (“FEC”) information to the video prior to being streamed by the first server to the user device, the FEC information sufficient to reproduce a missing IP packet of a group of IP packets of the received multicast video stream, the group of IP packets comprising a pre-selected number of sequential IP packets.

3. The apparatus of claim 2, wherein the requested IP packets of the video stream are not reproducible by the FEC information.

4. The apparatus of claim 1, wherein the correction signal module further comprises a unicast/multicast module configured to stream the one or more videos to the second server using a multicast and configured to transmit the requested IP packets to the second server using a unicast as requested by the second server, the requested IP packets requested by the second server to replace IP packets lacking in the one or more multicast videos received by the second server.

5. The apparatus of claim 1, further comprising an encoding module configured to encode IP packets of a video with a sequence identifier, the sequence identifier identifying a location of an IP packet with respect to other IP packets of a video.

6. The apparatus of claim 1, wherein the second server further comprises an option of streaming a video using a multicast to the user device as requested to replace missing IP packets lacking from the received multicast video received over the first IP network.

7. The apparatus of claim 6, wherein the second server selects between streaming the missing IP packets using a multicast and transmitting the missing IP packets using a unicast.

8. The apparatus of claim 6, wherein the second server selects between streaming the missing IP packets using a multicast and transmitting the missing IP packets using a unicast, the selection in response to an input from the user device.

9. The apparatus of claim 1, wherein the second server receives an input from the user device indicating missing IP packets from the second server in response to a determination that the user device has selected a new video channel not currently being transmitted to the user device, the missing IP packets comprising IP packets of the selected video received prior to receipt of time delayed IP packets of the new video channel from the first server.

10. The apparatus of claim 1, wherein the second server receives an input from the user device requesting missing IP packets from the second server in response to a determination that IP packets are missing from a video stream being received by the user device from the first server.

11. The apparatus of claim 1, wherein one of the one or more videos comprises a video signal and an audio signal.

12. The apparatus of claim 1, wherein the first IP network, the second IP network, and the third IP network comprise one of a single IP network and a plurality of IP networks acting as one network.

13. An apparatus to deliver video over an Internet Protocol (“IP”) network using multicast distribution and unicast correction, the apparatus comprising:
a correction receiver module configured to receive one or more streams of IP packets at a second server from a first server over a second IP network, the one or more streams from one or more videos;
a correction request module configured to receive a correction request over a third IP network from a user device, the correction request comprising a request for missing IP packets from a stream of IP packets of a first video, the stream of IP packets of the first video transmitted to the user device by the first server over a first IP network by way of a multicast, the transmitted IP packets at the user device of the first video time delayed from IP packets of the first video sent from the first server to the second server, the first server configured to stream IP packets from one or more videos to one or more user devices, each stream transmitted by way of a multicast; and
a correction sending module configured to transmit requested missing IP packets of the first video to the user device over the third IP network by way of a unicast, the requested missing IP packets of the first video for combination with the stream of IP packets of the first video transmitted to the user device by the first server to form a corrected video stream.

14. The apparatus of claim 13, further comprising an incoming packet correction module configured to request from the first server IP packets of a video and to receive the requested IP packets, the requested IP packets requested to replace IP packets missing from a stream of IP packets of a video, the stream of IP packets received from the first server by way of a multicast.

15. An apparatus to deliver video over an Internet Protocol (“IP”) network using multicast distribution and unicast correction, the apparatus comprising:
a receiver module configured to receive one or more videos from a first server over a first IP network using a multicast, each of the one or more videos formatted as IP packets, each of the one or more videos received from the first server being time delayed from a transmission of the same videos to a second server over a second IP network;
a packet analyzer module configured to determine if a stream of IP packets received by the receiver module is missing IP packets, the missing IP packets together with received IP packets from the first server forming a complete sequence of IP packets of a received video;
a packet request module configured to request and receive the missing IP packets from a second server over a third IP network; and
a packet assembly module configured to assemble the IP packets of the video received from the first server and the missing IP packets of the video received from the second server into the complete sequence of IP packets forming the video.

16. The apparatus of claim 15, further comprising a playback module configured to playback as a video the complete sequence of IP packets, the video comprising video and audio content.
